(19) United States
(12) Patent Application Publication
(10) Pub. No.: US 2016/0295129 A1
(43) Pub. Date: Oct. 6, 2016

(54) SYSTEM AND METHOD FOR CREATING TIME-LAPSE VIDEOS

(71) Applicant: Futurewei Technologies, Inc., Plano, TX (US)

(72) Inventor: Gauri Deshpande, San Diego, CA (US)

(21) Appl. No.: 14/673,286

(22) Filed: Mar. 30, 2015

(51) Int. Cl. H04N 5/262; H04N 5/232; H04N 5/272

(52) U.S. Cl. CPC H04N 5/2621; H04N 5/272; H04N 5/23222; H04N 5/23293

(57) ABSTRACT

Various disclosed embodiments include methods and systems for capturing images and creating time-lapse videos. A method includes receiving image data representative of an image that is to be used as part of an image sequence, and processing the image data using edge detection to assist a user to capture a subsequent image for the image sequence at substantially a same geographical location and substantially a same device orientation as that for other images in the image sequence.

### TECHNICAL FIELD

The present disclosure relates generally to time-lapse image capture.

### BACKGROUND

It may be desirable to capture a plurality of images in the form of a time-lapse image sequence in order to track development of a particular object or scene over time. For example, changing weather, changing seasons, a changing landscape, etc., are all things that can be monitored using a sequence of images captured at respective different times. The time period of interest can be relatively long—for example, weeks, months, a year, or multiple years, or can be relatively short.

Time-lapse photography is typically achieved by leaving a camera stationary in position and set to automatically take photographs separated by a pre-set time interval. This presents difficulties for a user because the time period is typically too long for an image capture device to be left in one place and the image capture device may be needed for other uses.

### SUMMARY

According to one embodiment, there is provided a method for creating a time-lapse video using an image capture device. The method includes receiving, at the image capture device, image data representative of an image that is to be used as part of an image sequence. The method includes processing, at the image capture device, the image data using edge detection to assist a user to capture a subsequent image for the image sequence at substantially a same geographical location and substantially a same device orientation as that for other images in the image sequence.

In another embodiment, there is provided an apparatus for capturing an image and creating a time-lapse video. The apparatus includes a processor and memory coupled to the processor, where the apparatus is configured to receive image data representative of an image that is to be used as part of an image sequence, and process the image data using edge detection to assist a user to capture a subsequent image for the image sequence at substantially a same geographical location and substantially a same device orientation as that for other images in the image sequence.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of an electronic device that is configured to capture images and to create time-lapse videos according to one embodiment;

FIG. 2 illustrates a flow diagram of an example method for capturing images and creating time-lapse videos according to one embodiment;

FIG. 3 illustrates a flow diagram of another example method for capturing images and creating time-lapse videos according to one embodiment;

FIG. 4 illustrates an example communication system that may be used for implementing the device and methods disclosed herein; and

FIGS. 5A and 5B illustrate example devices that may implement the methods and teachings disclosed herein.

### DETAILED DESCRIPTION

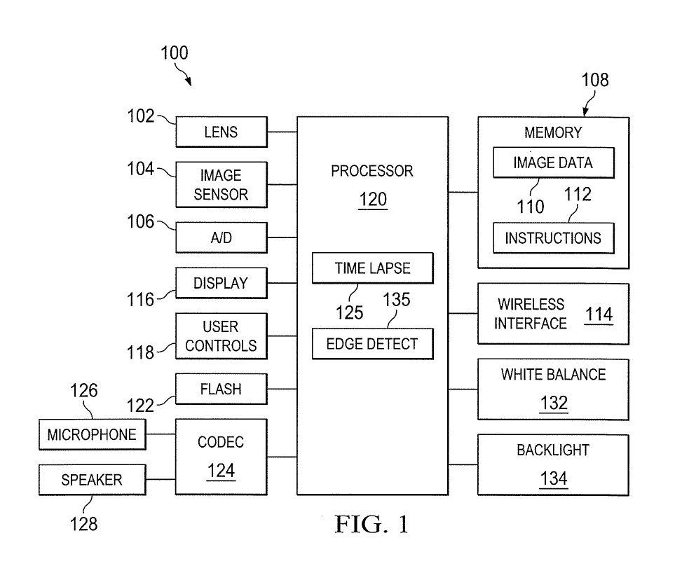

FIG. 1 illustrates a block diagram of an electronic device 100 that is configured to capture images and to create time-lapse videos. The electronic device 100 includes a lens 102 having an adjustable aperture. The lens 102 may be a zoom lens that is controlled by zoom and focus motor drives (not shown). The lens 102 focuses light from a scene (not shown) onto an image sensor 104 to capture image data that is processed, although this disclosure is not limited in this respect. The image sensor 104 may include arrays of solid state sensor elements, such as complementary metal-oxide semiconductor (CMOS) sensor elements, charge coupled device (CCD) sensor elements, or the like. Alternatively or additionally, the image sensor 104 may include a set of image sensors that include color filter arrays (CFAs) arranged on a surface of the respective sensors. One skilled in the art should appreciate that other types of image sensors could also be used to capture image data. The image sensor 104 may capture still images or full motion video sequences. In the latter case, image processing may be performed on one or more image frames of the video sequence.

The output of the image sensor 104 is converted to digital form by an analog-to-digital (AID) converter 106 and may be subsequently manipulated by a processor 120. The processor 120 is coupled to a memory 108 and is adapted to generate processed image data 110. The memory 108 is configured to receive and to store the processed image data 110, and a wireless interface 114 is configured to retrieve the processed image data 110 for transmission via an antenna (not shown). The memory 108 may store raw image data. The memory 108 may comprise dynamic random access memory (DRAM), synchronous DRAM (SDRAM), a non-volatile memory, such as flash memory, or any other type of data storage unit.

The electronic device 100 may include a display 116 that displays an image following image processing. After image processing, the image may be written to the memory 108 and the processed image may be sent to the display 116 for presentation to a user.

A coder/decoder (codec) 124 is coupled to the processor 120 and is configured to receive an audio signal from a microphone 126 and to provide an audio signal to a speaker 128. The microphone 126 and the speaker 128 can be used for telephone conversation. The microphone 126, the codec 124, and the processor 120 can be used to provide voice recognition so that a user can provide a user input to the processor 120 by using voice commands.

A graphical user interface may be displayed on the display 116 and may be controlled in response to user input provided by user controls 118. The user controls 118 may be used to initiate capture of still images and recording of motion images. The user controls 118 may be used to, among other things, turn on the camera, control the lens 102, and adjust camera functions including camera modes such as a portrait mode, a beach mode, an indoor mode, an outdoor mode, etc. The user controls 118 may be used to adjust other camera functions including camera settings such as adjusting a flash 122 setting, adjusting a white balance 132 setting, adjusting a backlight 134 setting, and initiating the picture taking process. At least some of the user controls 118 may be provided by using a touch screen overlay on the display 116. Alternatively or in addition, at least some of the user controls 118 may include buttons, rocker switches, joysticks, rotary dials, or any combination thereof.

The user controls 118 may include a control to enable a user to enter or exit a time-lapse mode. A time-lapse module 125 is configured to receive data from the user controls 118 and to determine whether to enter or exit a time-lapse mode in accordance with the received user control data. The time-lapse module 125 may be implemented as computer code that is executable at the processor 120, such as computer executable instructions that are stored at a computer readable medium. For example, program instructions 112 may include code to enter or exit a time-lapse mode.

The user controls 118 may include a control to create reference edges, to display reference edges, and/or to align reference edges that assist a user in aligning the electronic device 100 for subsequent image capture. An edge detect module 135 is configured to receive data from the user controls and to determine whether to create, display, or align reference edges in accordance with the received user control data. The edge detect module 135 may be implemented as computer code that is executable at the processor 120, such as computer executable instructions that are stored at a computer readable medium. For example, program instructions 112 may include code to create, display, or align reference edges.

The user controls 118 may include a control to identify a captured image as a first or “marked” image in a time-lapse project. The time-lapse project may include a sequence of images captured at respective different times in order to monitor the progression over a period of time of a feature of a scene or object in question. The marked image may be the image used for the purposes of alignment with future images for the time-lapse project as will be explained below in greater detail.

The electronic device 100 can prompt the user to enter the desired frequency of image capture for a time-lapse project, and the system can then give the user a reminder when the next image is due to be captured. A reminder may occur when the device is powered on at a time near or after the due time. Reminders may be associated with the user being in a location that is geographically close to the location where an image needs to be captured. For example, the electronic device 100 can include location functionality including but not limited to GPS functionality, in which case the electronic device 100 can determine its location, and when a location near an area at which an image of a sequence has been captured is approached, the electronic device 100 can notify a user to capture an image. The electronic device 100 can enable a user to terminate a time-lapse project at any time.

To capture the next image in the time-lapse project, the user identifies the time-lapse project it wishes to add to, preferably by selecting a particular marked image from a set of indexed marked images, one per time-lapse project. The marked image may be the first image of the time-lapse project, the most recent image in the time-lapse project, or another image within the time-lapse project. Alternatively, the marked image for a particular time-lapse project may not be an image from the time-lapse project, and instead may be any arbitrary image or symbol selected by the user. The user may decide to delete one or more of the images in the sequence.

The captured image assigned to a project can be downloaded to an external device such as a personal computer, a server, a tablet, a mobile phone, and the like. The electronic device 100 can be synchronized with the external device in order to exchange data relating to a project such as image data, reminder data or other project data. This may enable a time-lapse project to be shared with others and/or enable the time-lapse project to be a collaborative project.

An image which is to form part of a sequence for a time-lapse project can be captured with assistance from the electronic device 100 in determining a device position and/or orientation so that the electronic device 100 is located in substantially the same relative position each time an image is captured for the sequence. The electronic device 100 may include location functionality including but not limited to GPS functionality to determine a current location of the device, and enable a desired location to be determined The location functionality can be used to deter nine a current location of the electronic device 100 and inform the user where and how far to move in order to get the electronic device 100 into substantially the correct area for capturing images for a given sequence. In addition, the electronic device 100 can add a mark or a symbol in a current view of an image to indicate the point in the view where the marked image was captured.

The electronic device 100 may assist a user in making adjustments to relative position and/or orientation in order to ensure that subsequent images for a sequence are captured at substantially the same position and/or device orientation as previous images for the sequence. For example, the image presented to the user may be a combination of the marked image and the current device view. In this way the user can position the electronic device 100 such that it is viewing the scene in the same way as when the marked image was captured. To illustrate, the current view and the marked image can be superimposed or overlapped on the display 116 or in a viewfinder. Alternatively, an image to be captured and a marked image can be displayed alternately, or toggled between the two views by the user.

In a particular embodiment, a combination of a marked image and a current camera view can be displayed to a user by means of an edge enhanced version of the marked image superimposed on the current camera view. This can emphasize the alignment. Edges in the image can be determined using known edge detection techniques. For example, an edge detection algorithm or filter may be applied to the marked image to identify the desired edge features, and those desired edge features of the marked image may be selected and displayed (e.g., overlaid) on top of the current camera view image that are relevant to aligning the device for the subsequent image. The user may define how detailed the edges are that he/she wants to see. Alternatively, or in addition, the user may define static edges and remove non-useful edges.

The electronic device 100 may be configured to automatically capture the next image of the sequence in response to an acceptable image alignment between the marked image and the current view image. Positional shifts in images may be minimized by identifying a set of feature points which are visible in all images and locating their position in each image. For example, the feature points may be one or more stationary reference points defined by the device or by the user and when the reference points of the marked image and the current view image sufficiently coincide, the current view image may be automatically captured. In addition, once the set of common feature points is determined, each image can be transformed so that it is aligned with the marked image as well as possible. In addition, the electronic device 100 may be configured to automatically configure other camera functions including exposure parameters or camera settings such as the zoom setting, the flash setting, the white balance setting, the backlight setting, or other settings of the device to that used when the marked image was captured or to that used for a previously captured image of the project.

According to an illustrative embodiment, the electronic device 100 can suggest to a user to create a time-lapse project. This can occur when the electronic device 100 detects that it is at or near the same geographic location as it was on a previous occasion. The electronic device 100 can show the user the image captured at the nearby location and ask whether the user wishes to create a time-lapse project. Alternatively, the user may ask the electronic device 100 to search for images taken near the electronic device's current location. The user can then mark one of the previously taken images as the start of a time-lapse project.

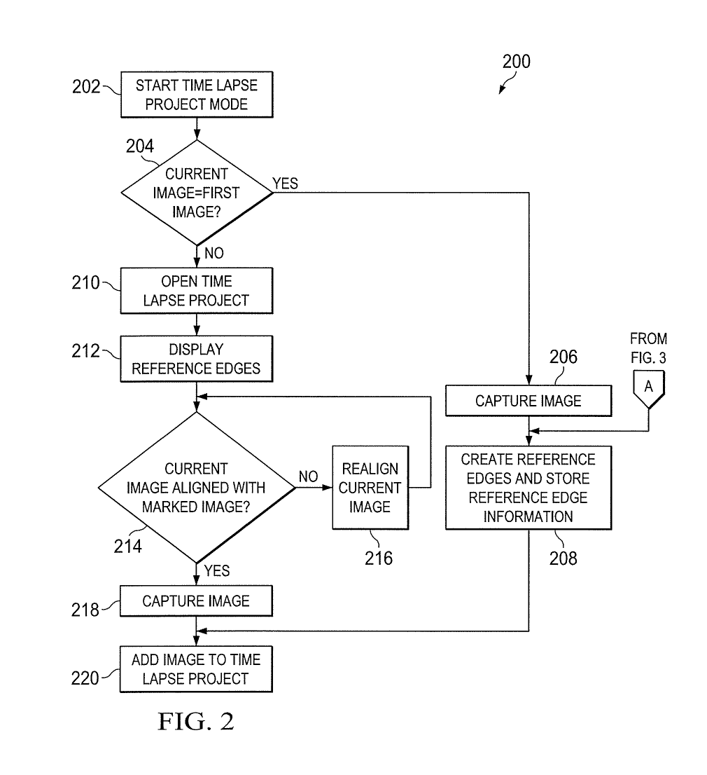

FIG. 2 illustrates a flow diagram of an example method 200 for creating time-lapse videos according to one embodiment. The processing illustrated in FIG. 2 may be implemented in software (e.g., computer-readable instructions, programs, code, etc.) that can be executed by one or more processors and/or other hardware components. In addition, or alternatively, the software may be stored on a non-transitory computer readable storage medium. For ease of explanation, the method may be described as being used in connection with one or more components in FIG. 1. Of course, the method may be used in any other suitable device or system.

At step 202, a user of the electronic device 100 starts a time-lapse project mode. The user may be prompted by the electronic device 100 to start the time-lapse project mode or the user may start the time-lapse project without being prompted by the electronic device 100.

At step 204, a determination is made whether image data representing the image to be captured (e.g., the current image in the viewfinder or displayed on the display 116) is a first image of an object or scene of which a time-lapse project is desired. If the current image is the first image of a time-lapse project, then at step 206 a user of the electronic device 100 captures the current image. The captured image may be “marked” via the user controls 118 as belonging to the particular time-lapse project. The user may be prompted by the electronic device 100 to set certain parameters for the time-lapse project, such as frequency of image capture and reminders.

At step 208, reference edges may be created that assist a user in aligning the electronic device 100 for subsequent image capture. Data associated with the reference edges may be stored in the memory 108. Thereafter, at step 220, the captured image is added to the time-lapse project. For example, metadata may be added into a header of the captured image to indicate which project the captured image relates to, and the captured image may be stored in the memory 108.

If at step 204 the current image is not the first image of the time-lapse project, then at step 210 the time-lapse project is opened, and at step 212, the reference edges are loaded and displayed.

At step 214, the electronic device 100 determines whether the current image is aligned with the marked image. For example, the electronic device 100 compares image data representing the image to be captured (e.g., the current image) with image data representing an image in the relevant project, and preferably with the marked image. The electronic device 100 may determine whether the image to be captured is sufficiently aligned with the captured image. This can be done by aligning the current image with the captured image via the reference edges as described above.

If it is determined that the image to be captured and the marked (or other project) image are not sufficiently aligned at step 214, then at step 216 the image to be captured can be altered. For example, the user can alter the relative position and/or orientation of the electronic device 100, or be prompted by the electronic device 100 to alter the relative position and/or orientation of the electronic device 100 in order to better align the image to be captured with the captured image in the project.

If it is determined at step 214 that alignment has been sufficiently achieved, the user may capture the image at step 218, and the captured image may then be added to the time-lapse project at step 220. Alternatively, the electronic device 100 can automatically capture the image in response to a desired level of alignment being achieved. As discussed above, the captured image may be added to the time-lapse project by adding metadata into a header of the captured image to indicate which project the captured image relates to, and the captured image may be stored in the memory 108.

Data associated with camera functions including camera settings used when the marked image was captured or when a previous image in the project was captured may be stored in the memory 108. For example, camera settings such as the zoom setting, the flash setting, the white balance setting, the backlight setting, etc. may be stored in the memory 108. As such, the electronic device 100 may be configured to automatically configure a zoom setting, a flash setting, a white balance setting, a backlight setting, or other camera settings of the device to that used when the marked image was captured or to that used for a previously captured image of the project.

Although FIG. 2 illustrates one example of a method 200 for creating time-lapse videos, various changes may be made to FIG. 2. For example, while shown as a series of steps, various steps shown in FIG. 2 could overlap, occur in parallel, occur in a different order, or occur multiple times. Moreover, some steps could be combined or removed and additional steps could be added according to particular needs.

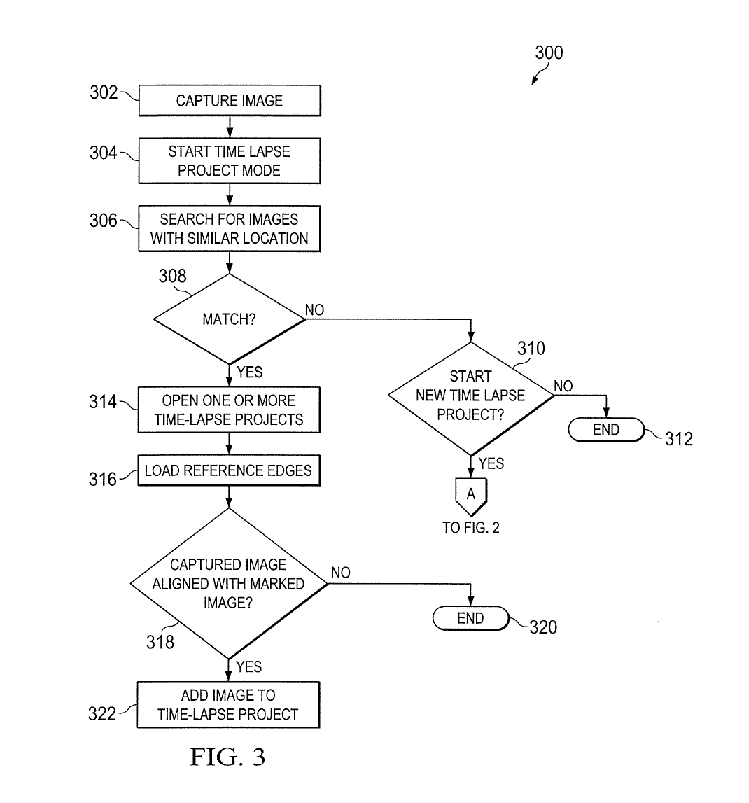

FIG. 3 illustrates a flow diagram of another example method 300 for capturing images and creating time-lapse videos. The processing illustrated in FIG. 3 may be implemented in software (e.g., computer-readable instructions, programs, code, etc.) that can be executed by one or more processors and/or other hardware components. In addition, or alternatively, the software may be stored on a non-transitory computer readable storage medium. For ease of explanation, the method 300 may be described as being used in connection with one or more components in FIG. 1. Of course, the method 300 may be used in any other suitable device or system.

At step 302, an image is captured by a user of the electronic device 100, and at step 304, the time-lapse project mode is started.

At step 306, the electronic device 100 determines if there are stored images in its memory which were taken at substantially the same location at a different day and/or time as the captured image. For example, following an image capture, the electronic device 100 can determine a location where the image was captured using location functionality, and compare this location with that of previously captured images in order to determine if the captured image can farm part of a project. In addition, the electronic device 100 may determine whether other parameters such as a desired frequency of image capture or a desired time to capture an image for a time-lapse project have been satisfied.

If at step 308 the electronic device 100 determines that it is not in a desired location, then at step 310 the electronic device determines whether a new time-lapse project is to be started. If a new time-lapse project is not to be started, then at step 312 the process ends. If a new time-lapse is to be started, then the procedure from step 208 of FIG. 2 begins.

If at step 308 the electronic device 100 determines that it is in a desired location, then at step 314, one or more time-lapse projects associated with the location is opened, and at step 316, the reference edges are loaded and displayed.

At step 318, the electronic device 100 determines whether the captured image is aligned with a corresponding marked image from one or more of the projects. For example, the electronic device 100 compares image data representing the captured image with image data representing an image in the relevant project, and preferably with the marked image. The electronic device 100 may determine whether the captured image is sufficiently aligned with the marked image. This can be done by aligning the captured image with the marked image via the reference edges.

If it is determined that the captured image and the marked (or other project) image are not sufficiently aligned at step 318, then at step 320 the process ends. If it is determined at step 318 that alignment has been sufficiently achieved, the captured image may be added to the time-lapse project at step 322.

The electronic device 100 can include one or more sensors to monitor device location (e.g., a GPS sensor; a Wi-Fi sensor; a Bluetooth sensor; etc.) and one or more sensors to monitor changes in device orientation caused by movement and/or rotation (e.g., an accelerometer, a gyroscope, etc.). For a captured image, the sensors can generate data representing the device location and orientation at the time of capture, which can be stored in an image header or as metadata associated with the image. The relevant data can then be compared with that generated by the sensors for a subsequent image capture operation for the sequence in question in order to determine how much the device should be adjusted (e.g., rotated and/or moved in a particular direction). The information can be presented to a user via the display 116 of the electronic device 100.

Although FIG. 3 illustrates one example of a method 300 for creating time-lapse videos, various changes may be made to FIG. 3. For example, while shown as a series of steps, various steps shown in FIG. 3 could overlap, occur in parallel, occur in a different order, or occur multiple times. Moreover, some steps could be combined or removed and additional steps could be added according to particular needs.

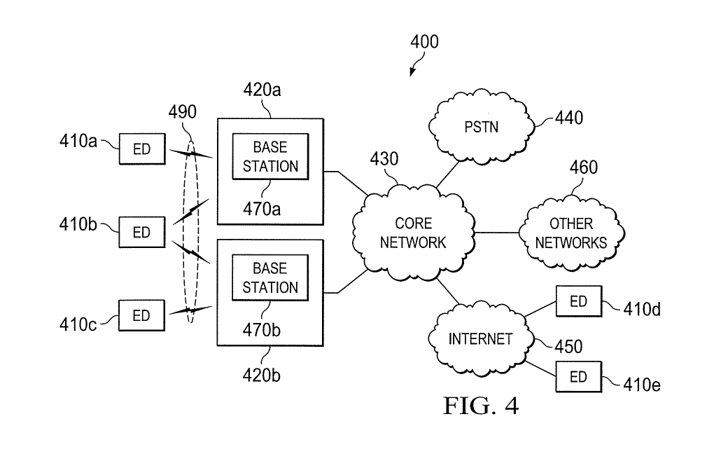

FIG. 4 illustrates an example communication system 400 that may be used for implementing the devices and methods disclosed herein. In general, the system 400 enables multiple wireless or wired users to transmit and receive data and other content. The system 400 may implement one or more channel access methods, such as code division multiple access (CDMA), time division multiple access (TDMA), frequency division multiple access (FDMA), orthogonal FDMA (OFDMA), or single-carrier FDMA (SC-FDMA).

In this example, the communication system 400 includes electronic devices (ED) 410a-410e, radio access networks (RANs) 420a-420b, a core network 430, a public switched telephone network (PSTN) 440, the Internet 450, and other networks 460, and one or more servers 470. While certain numbers of these components or elements are shown in FIG. 4, any number of these components or elements may be included in the system 400. As will be appreciated, each ED 410 may be the electronic device 100 shown in FIG. 1.

The EDs 410a-410e are configured to operate and/or communicate in the system 400. For example, the EDs 410a-410e are configured to transmit and/or receive via wireless or wired communication channels. Each ED 410a-410e represents any suitable end user device and may include such devices (or may be referred to) as a user equipment/device (UE), wireless transmit/receive unit (WTRU), mobile station, fixed or mobile subscriber unit, cellular telephone, personal digital assistant (PDA), smartphone, laptop, computer, touchpad, wireless sensor, or consumer electronics device, all which include and incorporate a browser application.

The RANs 420a-420b here include base stations 470a-470b, respectively. Each base station 470a-470b is configured to wirelessly interface with one or more of the EDs 410a-410c to enable access to the core network 430, the PSTN 440, the Internet 450, and/or the other networks 460. For example, the base stations 470a-470b may include (or be) one or more of several well-known devices, such as a base transceiver station (BTS), a Node-B (NodeB), an evolved NodeB (eNodeB), a Home NodeB, a Home eNodeB, a site controller, an access point (AP), or a wireless router. EDs 410d-410e are configured to interface and communicate with the internet 450 and may access the core network 430, the PSTN 440, and/or the other networks 460, which may include communicating with the server 470.

In the embodiment shown in FIG. 4, the base station 470a forms part of the RAN 420a, which may include other base stations, elements, and/or devices. Also, the base station 470b forms part of the RAN 420b, which may include other base stations, elements, and/or devices. Each base station 470a-470b operates to transmit and/or receive wireless signals within a particular geographic region or area, sometimes referred to as a “cell.” In some embodiments, multiple-input multiple-output (MIMO) technology may be employed having multiple transceivers for each cell.

The base stations 470a-470b communicate with one or more of the EDs 410a-410c over one or more air interfaces 490 using wireless communication links. The air interfaces 490 may utilize any suitable radio access technology.

It is contemplated that the system 400 may use multiple channel access functionality, including such schemes as described above. In particular embodiments, the base stations 470a-470b and EDs 410a-410c implement LTE, LTE-A, and/or LTE-B. Of course, other multiple access schemes and wireless protocols may be utilized.

The RANs 420a-420b are in communication with the core network 430 to provide the EDs 410a-410c with voice, data, application, Voice over Internet Protocol (VoIP), or other services. Understandably, the RANs 420a-420b and/or the core network 430 may be in direct or indirect communication with one or more other RANs (not shown). The core network 430 may also serve as a gateway access for other networks (such as PSTN 440, Internet 450, and other networks 460). In addition, some or all of the EDs 410a-410c may include functionality for communicating with different wireless networks over different wireless links using different wireless technologies and/or protocols. Instead of wireless communication (or in addition thereto), the EDs may communicate via wired communication channels to a service provider or switch (not shown), and to the Internet 450.

Although FIG. 4 illustrates one example of a communication system, various changes may be made to FIG. 4. For example, the communication system 400 could include any number of EDs, base stations, networks, or other components in any suitable configuration.

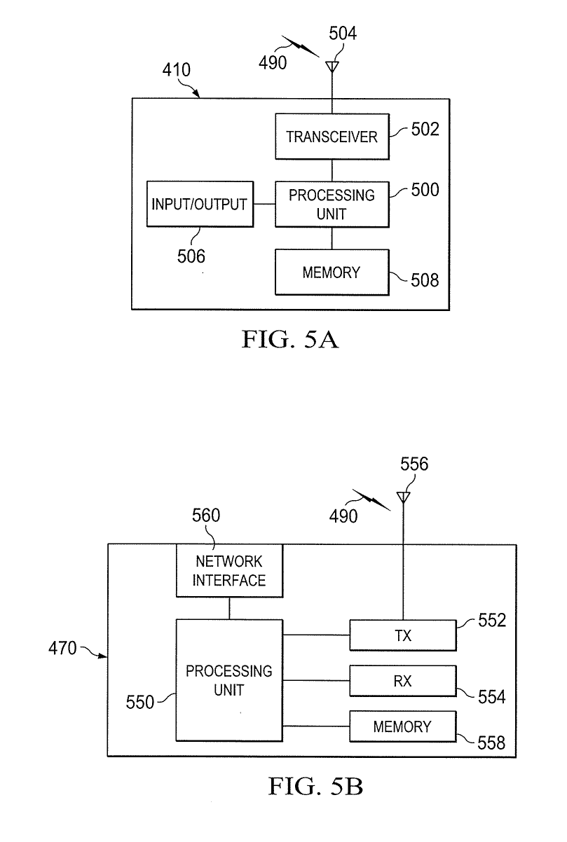

FIGS. 5A and 5B illustrate example devices that may implement the methods and teachings according to this disclosure. In particular, FIG. 5A illustrates an example ED 410, and FIG. 5B illustrates an example base station 470. These components could be used in the system 400 or in any other suitable system.

As shown in FIG. 5A, the ED 410 includes at least one processing unit 500. The processing unit 500 implements various processing operations of the ED 410. For example, the processing unit 500 could perform signal coding, data processing, power control, input/output processing, or any other functionality enabling the ED 410 to operate in the system 500. The processing unit 500 also supports the methods and teachings described in more detail above. Each processing unit 500 includes any suitable processing or computing device configured to perform one or more operations. Each processing unit 500 could, for example, include a microprocessor, microcontroller, digital signal processor, field programmable gate array, or application specific integrated circuit.

The ED 410 also includes at least one transceiver 502. The transceiver 502 is configured to modulate data or other content for transmission by at least one antenna or NIC (Network Interface Controller) 504. The transceiver 502 is also configured to demodulate data or other content received by the at least one antenna 504. Each transceiver 502 includes any suitable structure for generating signals for wireless or wired transmission and/or processing signals received wirelessly or by wire. Each antenna 504 includes any suitable structure for transmitting and/or receiving wireless or wired signals. One or multiple transceivers 502 could be used in the ED 410, and one or multiple antennas 504 could be used in the ED 410. Although shown as a single functional unit, a transceiver 502 could also be implemented using at least one transmitter and at least one separate receiver.

The ED 410 further includes one or more input/output devices 506 or interfaces (such as a wired interface to the internet 450). The input/output devices 506 facilitate interaction with a user or other devices (network communications) in the network. Each input/output device 506 includes any suitable structure for providing information to or receiving/providing information from a user, such as a speaker, microphone, keypad, keyboard, display, or touch screen, including network interface communications.

In addition, the ED 410 includes at least one memory 508. The memory 508 stores instructions and data used, generated, or collected by the ED 410. For example, the memory 508 could store software or firmware instructions executed by the processing unit(s) 500 and data used to reduce or eliminate interference in incoming signals. Each memory 508 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 5B, the base station 470 includes at least one processing unit 550, at least one transmitter 552, at least one receiver 554, one or more antennas 556, one or more wired network interfaces 560, and at least one memory 558. The processing unit 550 implements various processing operations of the base station 470, such as signal coding, data processing, power control, input/output processing, or any other functionality. The processing unit 550 can also support the methods and teachings described in more detail above. Each processing unit 550 includes any suitable processing or computing device configured to perform one or more operations. Each processing unit 550 could, for example, include a microprocessor, microcontroller, digital signal processor, field programmable gate array, or application specific integrated circuit.

Each transmitter 552 includes any suitable structure for generating signals for wireless or wired transmission to one or more EDs or other devices. Each receiver 554 includes any suitable structure for processing signals received wirelessly or by wire from one or more EDs or other devices. Although shown as separate components, at least one transmitter 552 and at least one receiver 554 could be combined into a transceiver. Each antenna 556 includes any suitable structure for transmitting and/or receiving wireless or wired signals. While a common antenna 556 is shown here as being coupled to both the transmitter 552 and the receiver 554, one or more antennas 556 could be coupled to the transmitter(s) 552, and one or more separate antennas 556 could be coupled to the receiver(s) 554. Each memory 458 includes any suitable volatile and/or non-volatile storage and retrieval device(s).

Additional details regarding EDs 410 and base stations 470 are known to those of skill in the art. As such, these details are omitted here for clarity.

In some embodiments, some or all of the functions or processes of the one or more of the devices are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terns “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for creating a time-lapse video using an image capture device, the method comprising:
receiving, at the image capture device, image data representative of an image that is to be used as part of an image sequence; and
processing, at the image capture device, the image data using edge detection to assist a user to capture a subsequent image for the image sequence at substantially a same geographical location and substantially a same device orientation as that for other images in the image sequence.

2. The method in accordance with claim 1, further comprising:
in response to the received image data representing a first image of the image sequence:
capturing the received image data; and
applying the edge detection to a portion of the captured image data that will overlap with a subsequent image of the image sequence to create reference edges.

3. The method in accordance with claim 1, further comprising:
prior to capturing the subsequent image, presenting an overlay image to the user, wherein the overlay image comprises the received image data and an edge enhanced version of an existing image in the image sequence.

4. The method in accordance with claim 3, further comprising:
in response to the received image data being aligned with the edge enhanced version of the existing image, capturing the received image data; and
adding the captured image data to a time-lapse project.

5. The method in accordance with claim 3, further comprising:
in response to the received image data being non-aligned with the edge enhanced version of the existing image, re-aligning the received image data.

6. The method in accordance with claim 1, further comprising:
determining a current geographical location of the device; and
in response to an existing image in the device being captured at a substantially similar geographic location as the current geographical location:
presenting an overlay image to the user, wherein the overlay image comprises the received image data and an edge enhanced version of the existing image that was captured at the substantially similar geographic location;
in response to the received image data being aligned with the edge enhanced version of the existing image that was captured at the substantially similar geographic location, capturing the received image data; and
adding the captured image data to a time-lapse project.

7. The method in accordance with claim 1, further comprising:
in response to the received image data representing a captured image:
determining a current geographical location of the device; and
in response to an existing image in the device being captured at a substantially similar geographic location as the current geographical location:
presenting an overlay image to the user, wherein the overlay image comprises the received image data and an edge enhanced version of the existing image that was captured at the substantially similar geographic location; and
in response to the received image data being aligned with the edge enhanced version of the existing image that was captured at the substantially similar geographic location, adding the captured image to a time-lapse project.

8. The method in accordance with claim 1, further comprising:
in response to the received image data representing a captured image:
determining a current geographical location of the device;
in response to an existing image in the device being captured at a substantially similar geographic location as the current geographical location:
automatically loading a time-lapse project in accordance with the current geographical location.

9. The method in accordance with claim 1, further comprising automatically adjusting parameters of the image capture device for the subsequent image in accordance with parameters used for an existing image in the image sequence.

10. An apparatus for image capture and for creating a time-lapse video, the apparatus comprising:
a processor; and
memory coupled to the processor;
wherein the apparatus is configured to:
receive image data representative of an image that is to be used as part of an image sequence; and
process the image data using edge detection to assist a user to capture a subsequent image for the image sequence at substantially a same geographical location and substantially a same apparatus orientation as that for other images in the image sequence.

11. The apparatus in accordance with claim 10, wherein the apparatus is further configured to:
in response to the received image data representing a first image of the image sequence:
capture the received image data; and
apply the edge detection to a portion of the captured image data that will overlap with a subsequent image of the image sequence to create reference edges.

12. The apparatus in accordance with claim 10, wherein the apparatus is further configured to:
prior to capturing the subsequent image, present an overlay image to the user, wherein the overlay image comprises the received image data and an edge enhanced version of an existing image in the image sequence.

13. The apparatus in accordance with claim 12, wherein the apparatus is further configured to:
in response to the received image data being aligned with the edge enhanced version of the existing image, capture the received image data; and
add the captured image data to a time-lapse project.

14. The apparatus in accordance with claim 12, wherein the apparatus is further configured to:
in response to the received image data being non-aligned with the edge enhanced version of the existing image, re-align the received image data.

15. The apparatus in accordance with claim 10, wherein the apparatus is further configured to:
determine a current geographical location of the apparatus; and
in response to an existing image in the apparatus being captured at a substantially similar geographic location as the current geographical location:
present an overlay image to the user, wherein the overlay image comprises the received image data and an edge enhanced version of the existing image that was captured at the substantially similar geographic location;
in response to the received image data being aligned with the edge enhanced version of the existing image that was captured at the substantially similar geographic location, capture the received image data; and
add the captured image data to a time-lapse project.

16. The apparatus in accordance with claim 10, wherein the apparatus is further configured to:
in response to the received image data representing a captured image:
determine a current geographical location of the apparatus; and
in response to an existing image in the apparatus being captured at a substantially similar geographic location as the current geographical location:
present an overlay image to the user, wherein the overlay image comprises the received image data and an edge enhanced version of the existing image that was captured at the substantially similar geographic location; and
in response to the received image data being aligned with the edge enhanced version of the existing image that was captured at the substantially similar geographic location, add the captured image to a time-lapse project.

17. The apparatus in accordance with claim 10, wherein the apparatus is further configured to:
in response to the received image data representing a captured image:
determine a current geographical location of the apparatus; and
in response to an existing image in the apparatus being captured at a substantially similar geographic location as the current geographical location:
automatically load a time-lapse project in accordance with the current geographical location.

18. The apparatus in accordance with claim 10, wherein the apparatus is further configured to automatically adjust parameters of the apparatus for the subsequent image in accordance with parameters used for an existing image in the image sequence.
